(19) United States
(12) Patent Application Publication
(10) Pub. No.: US 2017/0155530 A1
(43) Pub. Date: Jun. 1, 2017

(54) BASE STATION DEVICE, TRANSMISSION SYSTEM, AND TRANSMISSION METHOD

(71) Applicant: FUJITSU LIMITED, Kawasaki-shi (JP)

(72) Inventor: Manabu Shibata, Sendai (JP)

(73) Assignee: FUJITSU LIMITED, Kawasaki-shi (JP)

(21) Appl. No.: 15/342,341

(22) Filed: Nov. 3, 2016

(30) Foreign Application Priority Data
Dec. 1, 2015 (JP) 2015-234854

(51) Int. Cl. H04L 25/03; H04B 1/04; H04W 72/04

(52) U.S. Cl. CPC H04L 25/03866; H04W 72/0466; H04B 1/04

(57) ABSTRACT

A base station device includes a first electronic component and a second electronic component that are connected. The first electronic component includes a generator configured to generate data; scramblers configured to perform, by using different codes, a scrambling process on the data generated by the generator; and a sending driver configured to send, by using different transmission lines, signals obtained by being subjected to the scrambling process by the respective scramblers and the second electronic component includes a receiver configured to receive the signals transmitted by the sending driver; descramblers configured to perform, by using the codes used by the respective scramblers, a descrambling process on the respective signals received by the receiver; and a selector configured to select one of a plurality of pieces of data obtained by being subjected to the descrambling process by the respective descramblers.

### CROSS-REFERENCE TO RELATED APPLICATION

This application is based upon and claims the benefit of priority of the prior Japanese Patent Application No. 2015-234854, filed on Dec. 1, 2015, the entire contents of which are incorporated herein by reference.

### FIELD

The embodiments discussed herein are related to a base station device, a transmission system, and a transmission method.

### BACKGROUND

In recent years, in general, a great number of Large-Scale Integration (LSI) devices are mounted on, for example, base station devices that are used for wireless communication or information processing apparatuses that are used for information processing. Specifically, for example, a plurality of integrated circuits that are called field-programmable gate arrays (FPGAs) and that can be programmed may sometimes be arranged on a printed circuit board. These FPGAs are connected by, for example, transmission lines in an inner layer of a printed circuit board and receive and send signals with each other.

Because attenuation of signals occurs in the transmission lines between the FPGAs, the attenuation may sometimes be compensated in the transmission lines by using a process, such as pre-emphasis, equalization, or the like. Pre-emphasis is a process performed in an FPGA on the sending side and is a process of previously amplifying the power of the frequency band attenuated in a transmission line. Furthermore, equalization is a process performed in an FPGA on the receiving side and is a process of amplifying the frequency band attenuated in the transmission line. An example of the circuit that performs equalization includes a linear equalizer, a decision feedback equalizer (DFE), or the like.

In this way, by compensating attenuation of signals in each of the FPGAs on the sending side and the receiving side, data errors generated due to the attenuation in the transmission line is reduced.
Patent Document 1: Japanese Laid-open Patent Publication No. 2-100435
Patent Document 2: Japanese Laid-open Patent Publication No. 10-243054

However, recently, high-frequency signals with for example, 3 GHz or more are transmitted between a plurality of LSI devices and there is a problem in that, regarding such high-frequency signals, attenuation in the transmission lines is not sufficiently compensated. Specifically, when transmission lines are disposed in an inner layer of a printed circuit board, via holes passing through the printed circuit board are formed and parts on a surface layer of the printed circuit board are connected to the transmission lines in the inner layer via the via holes. At this time, because a wiring layer is the inner layer of the printed circuit board, in the via holes, a portion on the surface layer side in which the number of parts is less disposed than the wiring layer becomes a stub, reflection of high-frequency signal occurs. The reflected signal reflected at the stub is superimposed on the original high-frequency signal with a phase shifted by an amount corresponding to a delay due to the reflection; however, because the wavelength of the high-frequency signal is small, the effect of the phase shift is large and reflected signal with a phase close to the opposite phase of the original high-frequency signal may sometimes be superimposed. Consequently, a high-frequency signal to be received may sometimes be greatly degraded, which may sometimes cause data errors due to intersymbol interference.

In order to reduce the effect of the stub, there is a back drill technology that removes a stub due to excavation; however, it is difficult to completely remove the stub and thus attenuation of the high-frequency signal is not sufficiently compensated. Furthermore, the reflection of the high-frequency signal also occurs in an inconsistency portion of impedance generated due to the factor of, for example, a material of the printed circuit board, the structure of the via holes, or the like. Consequently, even if the stub is completely removed, the reflection of the high-frequency signal still occurs and degradation of the high-frequency signal due to the reflected signal occurs.

Furthermore, due to the reflection of the high-frequency signal described above, because the attenuation characteristic of the high-frequency signal on the frequency axis becomes nonlinear, it is further difficult to compensate the attenuation of the high-frequency signal. Namely, for example, in a linear equalizer that performs linear equalization, it is difficult to sufficiently compensate the attenuation of the high-frequency signal that has the nonlinear characteristic. Furthermore, the DFE can perform nonlinear equalization; however, in order to sufficiently compensate the attenuation of the high-frequency signal, the DFE with a large number of tap is mounted on an LSI device and thus the size of the circuit is increased.

### SUMMARY

According to an aspect of an embodiment, a base station device includes a first electronic component, and a second electronic component configured to connect to the first electronic component. The first electronic component includes a generator configured to generate data, a plurality of scramblers configured to perform, by using different codes, a scrambling process on the data generated by the generator, and a sending driver configured to send, by using different transmission lines, a plurality of signals obtained by being subjected to the scrambling process by the plurality of the respective scramblers to the second electronic component. The second electronic component includes a receiver configured to receive the plurality of the signals transmitted by the sending driver, a plurality of descramblers configured to perform, by using the codes used by the respective scramblers, a descrambling process on the plurality of the signals received by the receiver, and a selector configured to select one of a plurality of pieces of data obtained by being subjected to the descrambling process by the plurality of the respective descramblers.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a transmission system;

FIG. 2 is a block diagram illustrating the configuration of a sending side FPGA according to a first embodiment;

FIG. 3 is a block diagram illustrating the configuration of a receiving side FPGA according to the first embodiment;

FIG. 4 is a flowchart illustrating the flow of a data selecting process according to the first embodiment;

FIG. 5 is a block diagram illustrating the configuration of a receiving side FPGA according to a second embodiment;

FIG. 6 is a flowchart illustrating the flow of an abnormality detecting process according to the second embodiment;

FIG. 7 is a flowchart illustrating the flow of another abnormality detecting process according to the second embodiment;

FIG. 8 is a block diagram illustrating the configuration of a sending side FPGA according to a third embodiment;

FIG. 9 is a block diagram illustrating the configuration of a receiving side FPGA according to the third embodiment;

FIG. 10 is a flowchart illustrating the flow of an abnormality detecting process according to the third embodiment;

FIG. 11 is a block diagram illustrating the configuration of a receiving side FPGA according to a fourth embodiment;

FIG. 12 is a block diagram illustrating the configuration of an abnormality detecting unit according to the fourth embodiment;

FIG. 13 is a flowchart illustrating the flow of an abnormality detecting process according to the fourth embodiment;

FIG. 14 is a block diagram illustrating the configuration of a selection combining unit according to a fifth embodiment;

FIG. 15 is a flowchart illustrating the flow of a data selecting process according to the fifth embodiment;

FIG. 16 is a block diagram illustrating the configuration of a receiving side FPGA according to a sixth embodiment; and

FIG. 17 is a flowchart illustrating the flow of a data selecting process according to the sixth embodiment.

### DESCRIPTION OF EMBODIMENTS

Preferred embodiments of the present invention will be explained with reference to accompanying drawings. The present invention is not limited to the embodiments.

### [a] First Embodiment

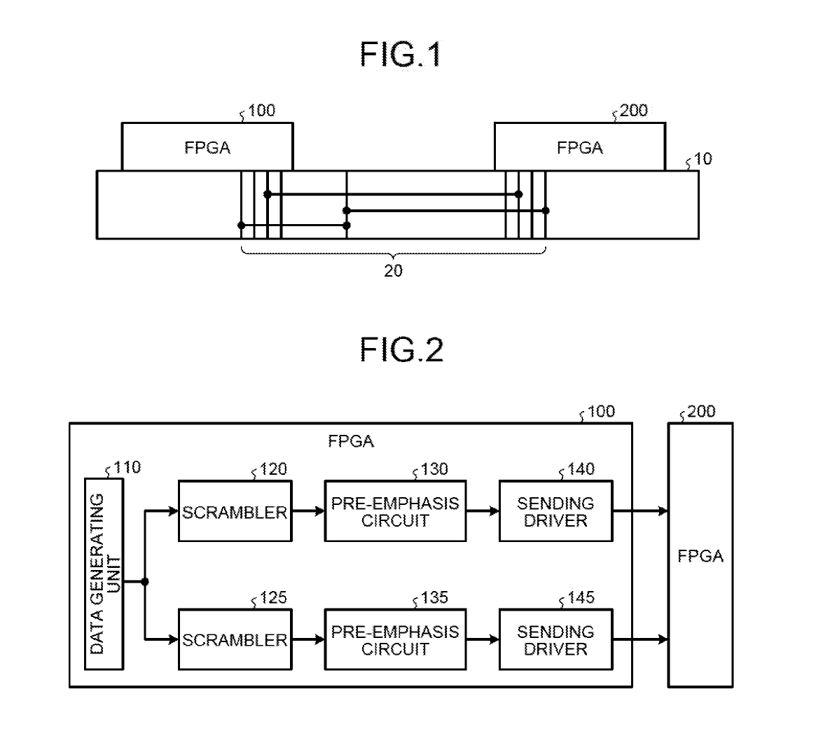

FIG. 1 is a schematic diagram illustrating an example of a transmission system. A transmission system illustrated in FIG. 1 is configured such that FPGAs 100 and 200 mounted on a surface layer of a printed circuit board 10 are connected by transmission lines 20 disposed in the inner layer of the printed circuit board 10. Such a transmission system is provided, for example, inside a base station device or an information processing apparatus.

The printed circuit board 10 is a multilayer board in which various kinds of electronic components can be mounted on the surface layer and wiring is possible in the inner layer. The transmission lines 20 are wiring patterns formed by printing metals, such as copper or the like, in the inner layer of the printed circuit board 10 and electrically connect between electronic components that are mounted on the surface layer of the printed circuit board 10. At the connecting portion in which a terminal of an electronic component is connected to the surface layer of the printed circuit board 10, via holes passing through the printed circuit board 10 are formed. Then, the transmission lines 20 connect, in the via holes, wiring patterns in different layers. Consequently, in the via holes, a stub may sometimes be formed on the surface layer side on which an electronic component of the printed circuit board 10 is not mounted.

The FPGAs 100 and 200 are programmable integrated circuits, are mounted on the surface layer of the printed circuit board 10, and perform various kinds of process. At the time of this process, the FPGAs 100 and 200 send and receive signals via the transmission lines 20. In the following, a description will be given with the assumption that the FPGA 100 is a sending side FPGA that generates data and that sends a signal including the generated data and the assumption that the FPGA 200 is a receiving side FPGA that receives the signal and performs a process by using the data included in the signal.

FIG. 2 is a block diagram illustrating the configuration of a sending side FPGA 100 according to a first embodiment. As illustrated in FIG. 2, the sending side FPGA 100 and a receiving side FPGA 200 are connected by at least two transmission lines and these two transmission lines are used to transmit the same data. The sending side FPGA 100 includes a data generating unit 110, scramblers 120 and 125, pre-emphasis circuits 130 and 135, and sending drivers 140 and 145.

The data generating unit 110 performs a process in accordance with a predetermined program installed in the sending side FPGA 100 and generates data. The generated data is the data that is sent to the receiving side FPGA 200.

The scramblers 120 and 125 perform a scrambling process on the data generated by the data generating unit 110. Specifically, for example, the scramblers 120 and 125 perform the scrambling process on the data by using codes, such as the M sequence or the Gold sequence of the Pseudo Noise (PN) codes. At this time, each of the scramblers 120 and the scrambler 125 performs a scrambling process on the data by using different codes. Accordingly, the scramblers 120 and 125 each perform different scrambling processes on the same data and output signals with different bit sequences. Furthermore, preferably, the scrambler 120 and the scrambler 125 perform the scrambling process on the data by using codes that are less correlated.

The pre-emphasis circuits 130 and 135 perform a pre-emphasis process on the signal that is obtained by having been subjected to the scrambling process. Namely, regarding the signals output from the respective scramblers 120 and 125, the pre-emphasis circuits 130 and 135 previously amplify the power of the frequency band attenuated in the transmission lines 20. Furthermore, the pre-emphasis circuits 130 and 135 may also previously amplify the power of frequency band attenuated in the transmission lines 20 from among the frequency bands that are lower than a predetermined frequency.

The sending drivers 140 and 145 amplify the signal that has been subjected to the pre-emphasis process and send the amplified signal to the receiving side FPGA 200 via the corresponding transmission lines. Namely, the sending driver 140 sends a signal A that is obtained by being amplified to the receiving side FPGA 200 via a path A and the sending driver 145 sends a signal B that is obtained by being amplified to the receiving side FPGA 200 via a path B.

As described above, because the scramblers 120 and 125 perform the scrambling process by using different codes, the signal A and the signal B are the signals with different bit sequences. Furthermore, because the signal A and the signal B are the signals with different bit sequences, the spectrum of the signal A is different from that of the signal B and the signals are attenuated by different attenuation characteristics in the path A and the path B, respectively, and are transmitted to the receiving side FPGA 200. Consequently, on the receiving side FPGA 200, by comparing the signal A and the signal B in units of bits and selecting bits in the signal in which an amount of attenuation is small, data with low error rate can be obtained. Consequently, even if a high-frequency signal that includes therein a component of the frequency band that is higher than the predetermined frequency, the attenuation in the transmission line can be sufficiently compensated.

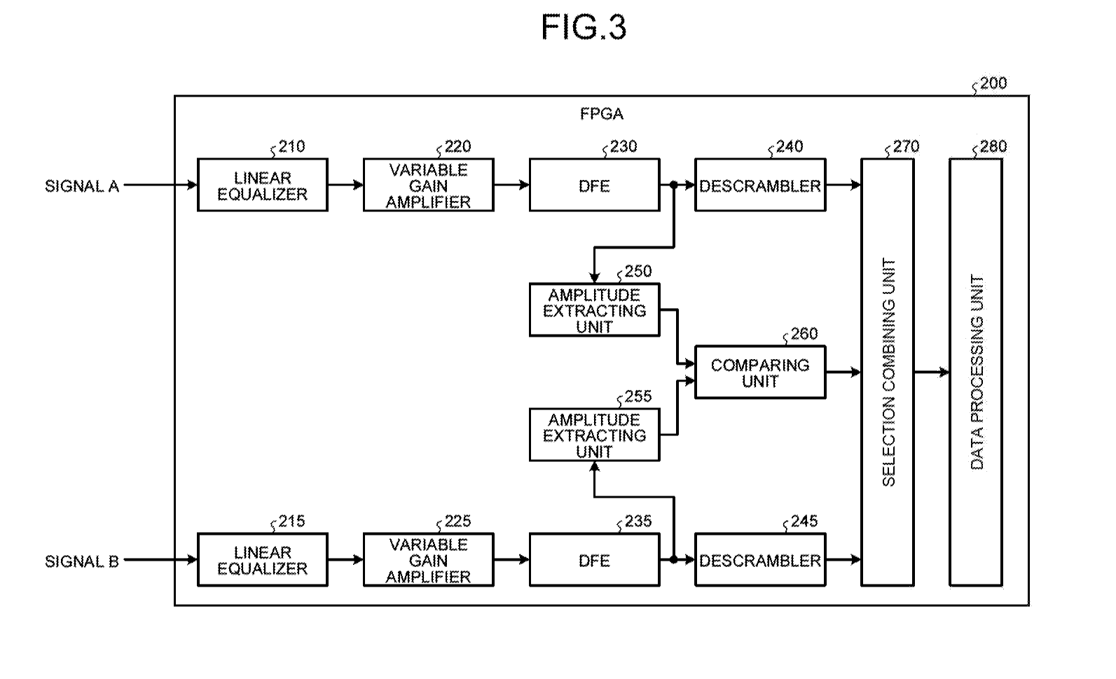

FIG. 3 is a block diagram illustrating the configuration of the receiving side FPGA 200 according to the first embodiment. The receiving side FPGA 200 illustrated in FIG. 3 includes linear equalizers 210 and 215, variable gain amplifiers 220 and 225, DFEs 230 and 235, descramblers 240 and 245, amplitude extracting units 250 and 255, a comparing unit 260, a selection combining unit 270, and a data processing unit 280.

The linear equalizers 210 and 215 receive the signal A and the signal B, respectively, and perform linear equalization on the signal A and the signal B, respectively. Namely, the linear equalizers 210 and 215 perform the linear equalization on the signal A and the signal B attenuated in the path A and the path B, respectively, and amplify the power of the attenuated frequency band.

The variable gain amplifiers 220 and 225 amplify the signal A and the signal B, respectively, by variable gains. The amplification performed by the variable gain amplifiers 220 and 225 is amplification performed on all of the frequency bands of the signals.

The DFEs 230 and 235 multiply a plurality of tap coefficients by the signal A and the signal B, respectively, and feed back the multiplication results, thereby adjusting the respective tap coefficients. Then, the DFEs 230 and 235 multiply the plurality of adjusted tap coefficients by the signal A and the signal B, respectively, and perform nonlinear equalization. In this way, because the DFEs 230 and 235 perform equalization on the respective signals while performing the determination related to the tap coefficients on the basis of the fed back multiplication results, the nonlinear equalization performed by the DFEs 230 and 235 is sometimes referred to as determination feedback type equalization.

By performing the processes performed by the linear equalizers 210 and 215, the variable gain amplifiers 220 and 225, and the DFEs 230 and 235, the attenuation in the frequency bands that are related to the signal A and the signal B and that are mainly lower than the predetermined frequency can be compensated.

The descramblers 240 and 245 perform a descrambling process on the signal A and the signal B by using the codes that are used by the scramblers 120 and 125, respectively, in the sending side FPGA 100. Namely, the descrambler 240 obtains data A from the signal A by performing inverse transformation of the scrambling process performed by the scrambler 120. Furthermore, the descrambler 245 obtains data B from the signal B by performing inverse transformation of the scrambling process performed by the scrambler 125. Furthermore, because the scramblers 120 and 125 perform different scrambling processes on the same data, if the effect, such as attenuation or the like, in the transmission line is not present, the data A and the data B match. The descramblers 240 and 245 output the data A and the data B, respectively, to the selection combining unit 270. At this time, the descramblers 240 and 245 output the data A and the data B, respectively, one bit at a time to the selection combining unit 270.

The amplitude extracting units 250 and 255 extract the amplitude of the signal A and the signal B, respectively. Namely, the amplitude extracting unit 250 extracts an amplitude A of the signal A and the amplitude extracting unit 255 extracts an amplitude B of the signal B. Then, the amplitude extracting units 250 and 255 output the amplitude A and the amplitude B, respectively, to the comparing unit 260. Furthermore, the amplitude extracting units 250 and 255 extract the instantaneous amplitude of the signal A and the signal B, respectively, for each signal waveform that corresponds to one bit. The amplitude extracting units 250 and 255 may also be constructed by using a plurality of operational amplifiers or comparators to which, for example, different threshold voltages are input.

The comparing unit 260 compares the magnitude of the amplitude A and the amplitude B of the signal A and the signal B, respectively, and instructs the selection combining unit 270 to select the data associated with the signal in which the amplitude is greater. Namely, the comparing unit 260 instructs the selection combining unit 270 to select, if the amplitude A is greater than the amplitude B, the data A that is associated with the signal A. Furthermore, if the amplitude B is greater than the amplitude A, the comparing unit 260 instructs the selection combining unit 270 to select the data B that is associated with the signal B.

The selection combining unit 270 selects the data A or the data B in accordance with the instruction from the comparing unit 260 and outputs the selected data to the data processing unit 280. Namely, the selection combining unit 270 sequentially outputs, to the data processing unit 280, the bits in the data, between the data A and the data B that are output one bit at a time from the descramblers 240 and 245, respectively, in which the instantaneous amplitude of the signal waveform associated with the bits is greater.

The data processing unit 280 performs, in accordance with a predetermined program installed in the receiving side FPGA 200, a process on the data output from the selection combining unit 270.

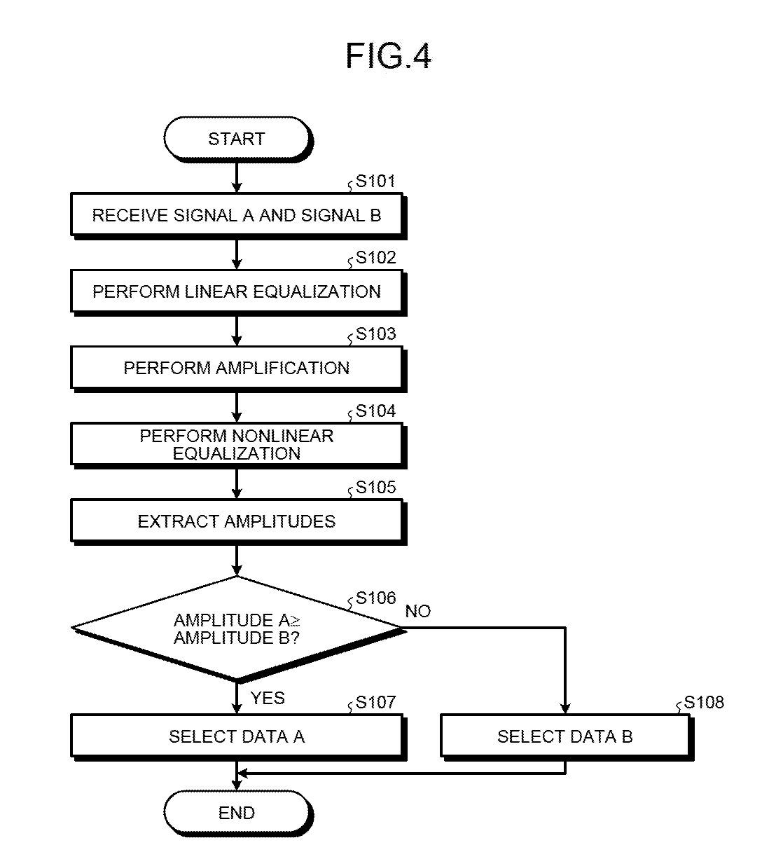

In the following, the data selecting process performed by the receiving side FPGA 200 configured as described above will be described with reference to the flowchart illustrated in FIG. 4.

The signal A and the signal B that are obtained from the same data subjected to the scrambling process in the sending side FPGA 100 by using different codes are transmitted by using different path A and the path B, respectively. The signal A and the signal B are received by the receiving side FPGA 200 (Step S101), and are subjected to linear equalization by the linear equalizers 210 and 215, respectively (Step S102). Then, the signal A and the signal B are amplified by the variable gain amplifiers 220 and 225, respectively (Step S103) and are subjected to nonlinear equalization by the DFEs 230 and 235, respectively (Step S104). With these processes, the attenuation mainly in the low-frequency component of the signal A and the signal B is compensated. However, regarding the high-frequency component, for example, due to the effect of the reflection caused by stubs or the like formed in the path A and the path B, attenuation is not sufficiently compensated.

The signal A and the signal B that have been subjected to equalization are subjected to the descrambling process by the descramblers 240 and 245, respectively. For the descrambling process, the same codes as that used by the respective scramblers 120 and 125 in the sending side FPGA 100 are used. Namely, the signal A is subjected to the descrambling process by the descrambler 240 by using the same code as that used by the scrambler 120. Furthermore, the signal B is subjected to the descrambling process by the descrambler 245 by using the same code as that used by the scrambler 125. Due to the descrambling process, the data A is obtained from the signal A and the data B is obtained from the signal B. The data A and the data B are output to the selection combining unit 270. Furthermore, the data A and the data B are the same data unless degradation or the like of the signal in the transmission line is present.

The descrambling process is processed, whereas the amplitude of the signal A and the signal B that are output from the DFEs 230 and 235, respectively, are extracted by the amplitude extracting units 250 and 255, respectively (Step S105). Here, the instantaneous amplitudes associated with the signal waveforms of the signal A and the signal B that are subjected to the descrambling process by the descramblers 240 and 245, respectively, are extracted. Then, the magnitude of the extracted amplitudes is compared by the comparing unit 260 (Step S106). Namely, the magnitude of the amplitude A of the signal A is compared with the magnitude of the amplitude B of the signal B by the comparing unit 260 and it is determined to select the data associated with the signal having a larger amplitude. Specifically, if the magnitude of the amplitude A is equal to or greater than that of the amplitude B (Yes at Step S106), it is determined that the data A associated with the signal A is selected (Step S107) and this information is notified to the selection combining unit 270. In contrast, if the magnitude of the amplitude A is equal to or greater than that of the amplitude B (No at Step S106), it is determined that the data B associated with the signal B is selected (Step S108) and this information is notified to the selection combining unit 270.

If the selection result of the data is notified to the selection combining unit 270, the data that is in accordance with the selection result is output to the data processing unit 280 by the selection combining unit 270. Namely, if the data A is selected, the data A output from the descrambler 240 is output from the data processing unit 280 and, if the data B is selected, the data B output from the descrambler 245 is output to the data processing unit 280. The process that is in accordance with a predetermined program installed in the receiving side FPGA 200 is performed, by the data processing unit 280, on these pieces of the data.

In this way, in the receiving side FPGA 200, the amplitude of the signal A and the signal B is compared and the data that is obtained from the signal that has a larger amplitude and that has been subjected to the descrambling process is selected. Consequently, the data that is obtained from the signal attenuated due to, for example, the effect of the reflection is not selected and it is possible to reduce an error rate of the selected data.

As described above, according to the embodiment, the sending side FPGA performs the scrambling process on the same data by using different codes and sends the obtained signals by using the different transmission lines, respectively. Furthermore, the receiving side FPGA performs the descrambling process on the signals transmitted from the different transmission lines by using the respective same codes as those used for the scrambling process and selects the data associated with the signal having a larger amplitude between the obtained pieces of data. Consequently, it is possible to select the data that is obtained from the signal in which the effect of reflection or the like with respect to the high-frequency component is small and it is possible to reduce the error rate of the data. In other words, it is possible to sufficiently compensate the attenuation of the signal with a high frequency band.

### [b] Second Embodiment

The characteristic of a second embodiment is that abnormality of the transmission line is detected on the basis of the number of times data is selected and the data that is obtained from the signal transmitted by the transmission line in which no abnormality is present is fixedly selected.

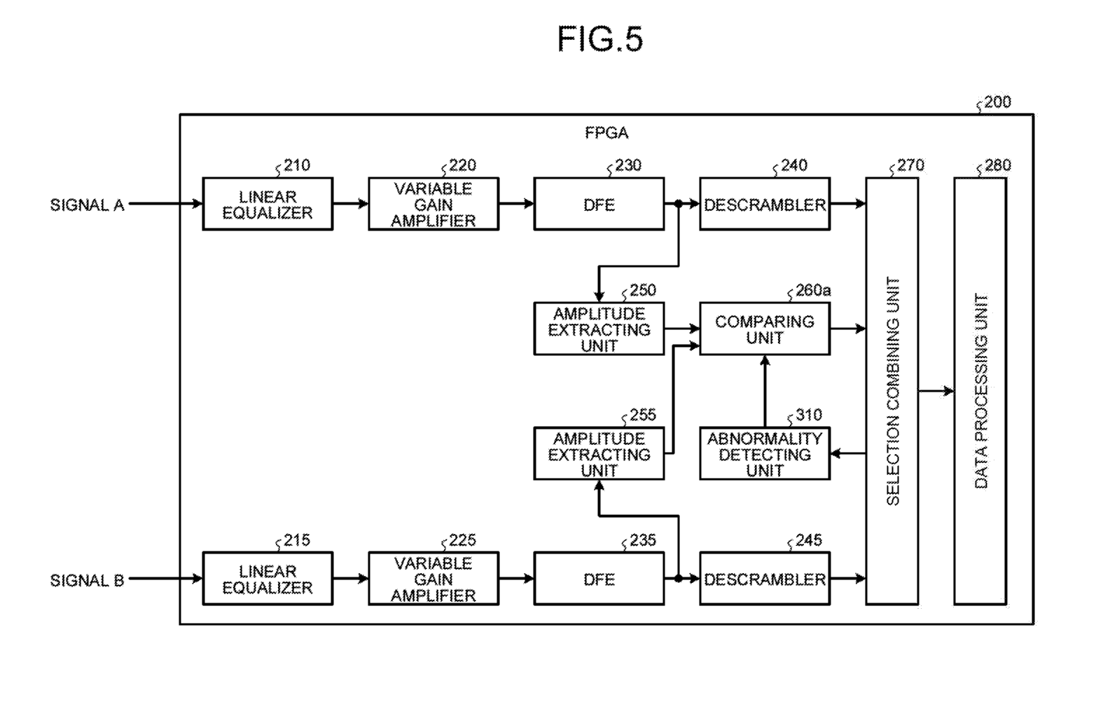

The configuration of the sending side FPGA according to the second embodiment is the same as that of the sending side FPGA 100 (FIG. 2) according to the first embodiment; therefore, descriptions thereof will be omitted. FIG. 5 is a block diagram illustrating the configuration of the receiving side FPGA 200 according to a second embodiment. In FIG. 5, components having the same configuration as those illustrated in FIG. 3 are assigned the same reference numerals and descriptions thereof will be omitted. The receiving side FPGA 200 illustrated in FIG. 5 has the configuration in which the comparing unit 260 in the receiving side FPGA 200 illustrated in FIG. 3 is changed to a comparing unit 260a and an abnormality detecting unit 310 is added.

The comparing unit 260a compares the magnitude of the amplitude A and the amplitude B of the signal A and the signal B, respectively, and instructs the selection combining unit 270 to select the data that is associated with the signal that has a larger amplitude. Namely, if the amplitude A is larger than the amplitude B, the comparing unit 260a instructs the selection combining unit 270 to select the data A that is associated with the signal A. Furthermore, if the amplitude B is greater than the amplitude A, the comparing unit 260a instructs the selection combining unit 270 to select the data B that is associated with the signal B.

Furthermore, if an instruction is received from the abnormality detecting unit 310, the comparing unit 260a instructs the selection combining unit 270 to select the data that is associated with one of the signals regardless of the comparison result of the amplitude. Namely, if abnormality is detected in one of the transmission lines, the comparing unit 260a instructs the selection combining unit 270 to fixedly select the data that is associated with the signal transmitted by the transmission line in which no abnormality is present.

The abnormality detecting unit 310 monitors the data selected by the selection combining unit 270 and determines whether the selected data is not biased. Specifically, the abnormality detecting unit 310 monitors which one of the data A and the data B is selected by the selection combining unit 270 and compares the frequency of selection of the respective pieces of the data. Namely, for example, in selection of the data performed a predetermined number of times by the selection combining unit 270, the abnormality detecting unit 310 calculates a difference between the number of times the data A has been selected and the number of times the data B has been selected. Then, the abnormality detecting unit 310 compares the calculated difference with a predetermined threshold and, if the difference is equal to or greater than a predetermined threshold, the abnormality detecting unit 310 detects that abnormality occurs in the transmission line. Namely, the abnormality detecting unit 310 detects that abnormality occurs in a passing route of the data that is less frequently selected. Accordingly, if, for example, the number of times the data A has been selected is equal to or less than the number of times the data B has been selected, the abnormality detecting unit 310 detects that abnormality occurs in the path A that is the pass route of the data A. Then, the abnormality detecting unit 310 instructs the comparing unit 260a to fixedly select the data that has passed through the path in which no abnormality is detected. Namely, if the abnormality detecting unit 310 detects that abnormality occurs in, for example, the path A, the abnormality detecting unit 310 instructs the comparing unit 260a to fixedly select the data B that has passed through the path B.

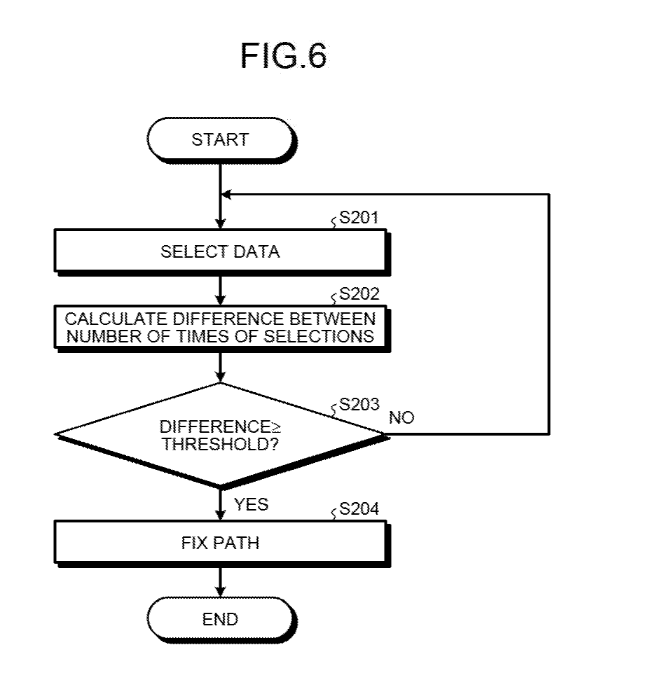

In the following, an abnormality detecting process performed by the receiving side FPGA 200 configured as described above will be described with reference to the flowchart illustrated in FIG. 6.

In also the second embodiment, similarly to the first embodiment, by comparing the amplitude A and the amplitude B of the signal A and the signal B, respectively, the data A or the data B is selected and is output from the selection combining unit 270 (Step S201). The selection of the data performed by the selection combining unit 270 is monitored by the abnormality detecting unit 310 and, in the selection of the data performed the predetermined number of times, a difference between the number of times the data A has been selected and the number of times the data B has been selected is calculated (Step S202). The difference becomes greater when the frequency of the selection of the data is biased. Thus, the difference calculated by the abnormality detecting unit 310 is compared with a predetermined threshold (Step S203).

If the result of this comparison indicates that the calculated difference is less than the predetermined threshold (No at Step S203), it is determined that the frequency of the selection of the data is not biased and determined that no abnormality is present in both the path A and the path B. Consequently, data A or the data B is continuously selected by comparing the amplitude A and the amplitude B of the signal A and the signal B, respectively.

In contrast, if the result of the comparison at Step S203 indicates that the calculated difference is equal to or greater than the predetermined threshold (Yes at Step S203), it is determined that the frequency of the selection of the data is biased and determined that abnormality is present in the transmission line. Specifically, it is determined that abnormality is present in the path through which the data that was less frequently selected. Accordingly, if, for example, the number of times the data A has been selected is less than the number of times the data B has been selected, it is determined that abnormality is present in the path A through which the data A has passed. If abnormality of the transmission line is detected, the comparing unit 260a is instructed, by the abnormality detecting unit 310, to fixedly select the data that has passed through the path in which no abnormality is present. In response to this instruction, the selection combining unit 270 is instructed, by the comparing unit 260a regardless of the magnitude of the amplitudes, to select the data that has passed through the instructed path. Consequently, the data that is output from the selection combining unit 270 to the data processing unit 280 is fixed to the data that has passed through the path in which no abnormality is present (Step S204).

As described above, according to the embodiment, selecting data performed by comparing the amplitudes of the signals each have been transmitted by different transmission lines is monitored and, if the frequency of the selection is biased, it is detected that abnormality is present in the transmission line that is less frequently selected. Then, the data associated with the signal that has been transmitted by the transmission line in which no abnormality is present is fixedly selected. Consequently, it is possible to promptly detect abnormality present in the transmission line between the sending side FPGA and the receiving side FPGA and it is possible to reduce the error rate of the data because the data passing through the transmission line in which abnormality is present is not selected.

Furthermore, in the second embodiment described above, if abnormality of the transmission line is detected by the abnormality detecting unit 310, the detection of the abnormality may also be notified to a higher-level device that is not illustrated. This notification may also indicate that, for example, detection of the abnormality is obtained from which one of the transmission lines. In this way, by notifying the higher-level device of the occurrence of the abnormality, it is possible for, for example, a maintenance person of the base station device to promptly detect abnormality of the transmission line and implement quick recovery.

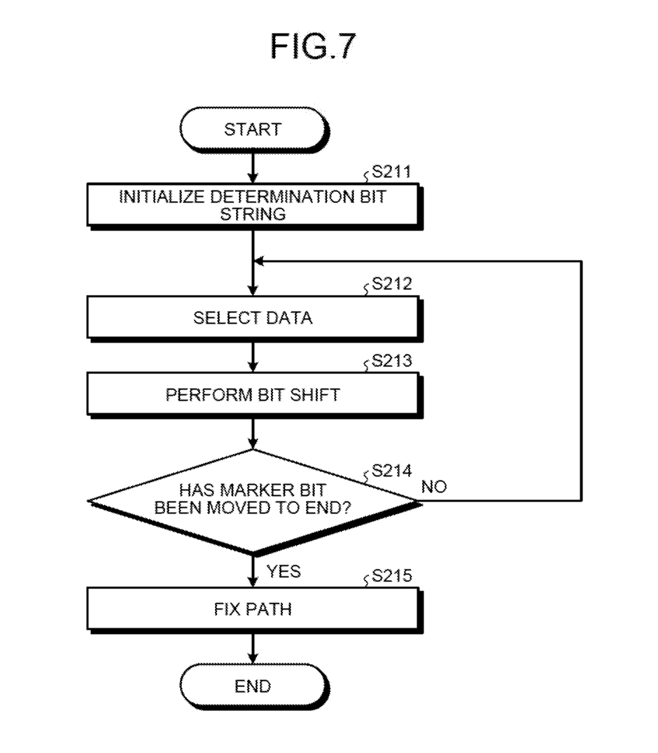

Furthermore, in the second embodiment described above, the bias of the frequency of the selection is determined on the basis of the difference of the number of times the data has been selected; however, the bias of the frequency of the selection may also be determined by using another method. FIG. 7 is a flowchart illustrating the flow of another abnormality detecting process according to the second embodiment. In the abnormality detecting process illustrated in FIG. 7, the bias of the frequency the data is selected is determined by using a determination bit string formed by a plurality of bits.

The abnormality detecting unit 310 holds a determination bit string that is formed by a plurality of bits and in which a single bit is used as a marker bit. Then, when a process of detecting abnormality of the transmission line is started, the determination bit string is initialized (Step S211). The determination bit string is a bit string in which, for example, the marker bit is “1” and all of the other bits are “0”. When the determination bit string is initialized, the bit present at the center of the determination bit string is set to “1” that indicates the marker bit.

In contrast, by comparing the amplitude A and the amplitude B of the signal A and the signal B, respectively, by the comparing unit 260a, the data A or the data B is selected and is output to the selection combining unit 270 (Step S212). Selecting the data performed by the selection combining unit 270 is monitored by the abnormality detecting unit 310 and a bit shift of the determination bit string is performed in accordance with the selected data (Step S213). Specifically, if, for example, the data A is selected, a bit shift is performed such that the marker bit is moved to a higher level by 1 bit. Furthermore, if, for example, the data B is selected, a bit shift is performed such that the marker bit is moved to a lower level by 1 bit. The direction of the movement of the marker bit may also be uniquely associated with the selected data and, if, for example, the data A is selected, the marker bit may also be moved to the lower level by 1 bit.

If the bit shift of the determination bit string has been performed, the abnormality detecting unit 310 determines whether the marker bit has been moved to the most significant bit or the least significant bit of the determination bit string (Step S214). If the determination result indicates that the marker bit is not moved to the most significant bit or the least significant bit (No at Step S214), the bit shift of the determination bit string is repeated every time the data is selected.

Then, if the marker bit is moved to the most significant bit or the least significant bit (Yes at Step S214), it is determined that the frequency of the selection of the data is biased and abnormality is present in the transmission line. Namely, the movement of the marker bit positioned at the center of the determination bit string to the end of the determination bit string due to the initialization in the movement direction associated with the selected data indicates that the frequency of the selection of one of the data is high. Thus, it is determined that abnormality is present in the path through which the data that is less frequently selected passes. Accordingly, if the marker bit arrives at the end of the movement direction that is used when, for example, the data B is selected, it is determined that abnormality is present in the path A through which the data A has passed.

If the abnormality of the transmission line is detected, the comparing unit 260a is instructed by the abnormality detecting unit 310 to fixedly select the data that has passed the path in which no abnormality is present. In response to this instruction, the selection combining unit 270 is instructed by the comparing unit 260a to select the data that has passed the instructed path regardless of the magnitudes of the amplitudes. Consequently, the data that is output from the selection combining unit 270 to the data processing unit 280 is fixed to the data that has passed through the path in which no abnormality is present (Step S215).

In this way, instead of simply determining the frequency of the selection of the data on the basis of the difference of the number of times of the selection, it is also possible to determine, by using the determination bit string, whether one of the pieces of the data is selected in a predetermined time period in a concentrated manner.

### [c] Third Embodiment

The characteristic of a third embodiment is that, if abnormality of the transmission line is detected, the codes that are used for the scrambling process and the descrambling process are changed.

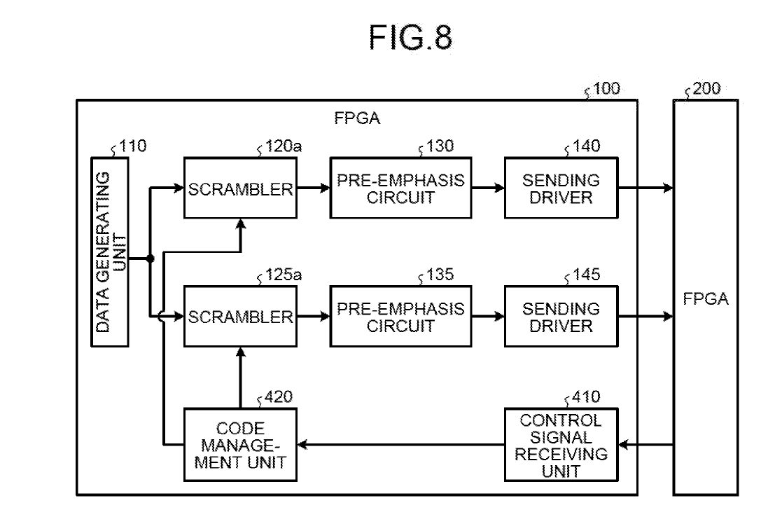

FIG. 8 is a block diagram illustrating the configuration of the sending side FPGA 100 according to a third embodiment. In FIG. 8, components having the same configuration as those illustrated in FIG. 2 are assigned the same reference numerals and descriptions thereof will be omitted. The sending side FPGA 100 illustrated in FIG. 8 has the configuration in which scramblers 120 and 125 in the sending side FPGA 100 illustrated in FIG. 2 are changed to scramblers 120a and 125a, respectively, and a control signal receiving unit 410 and a code management unit 420 are added.

The scramblers 120a and 125a perform a scrambling process on the data generated by the data generating unit 110. Specifically, the scramblers 120a and 125a perform the scrambling process on the data by using, for example, the codes, such as the M sequence or the Gold sequence of the PN codes or the like. At this time, both the scrambler 120a and the scrambler 125a perform the scrambling process on the data by using different codes specified by the code management unit 420. Accordingly, the scramblers 120a and 125a perform different scrambling processes on the same data and output the signals with different bit sequences. Furthermore, preferably, the scrambler 120a and the scrambler 125a perform the scrambling process on the data by using the codes that have low correlation with each other.

Furthermore, the scramblers 120a and 125a change, in accordance with the instruction from the code management unit 420, the codes that are used for the scrambling process.

The control signal receiving unit 410 receives, from the receiving side FPGA 200, a control signal indicating that abnormality occurs in the transmission line between the sending side FPGA 100 and the receiving side FPGA 200. The control signal received by the control signal receiving unit 410 may also be a signal with a speed and frequency that are lower than those of the signal sent from the sending drivers 140 and 145 and preferably be a signal with a high error tolerance.

The code management unit 420 manages the codes used by the scramblers 120a and 125a. Specifically, the code management unit 420 designates, with respect to the scramblers 120a and 125a, the codes that have low correlation with each other. Then, if the control signal is received by the control signal receiving unit 410, the code management unit 420 designates, with respect to the scramblers 120a and 125a, the code that is different from the code that is currently being used. Namely, if abnormality occurs in the transmission line, the code management unit 420 changes the code that is used for the scrambling process in accordance with the predetermined rule. At this time, the code management unit 420 also designates, with respect to the scramblers 120a and 125a, the codes that have low correlation with each other.

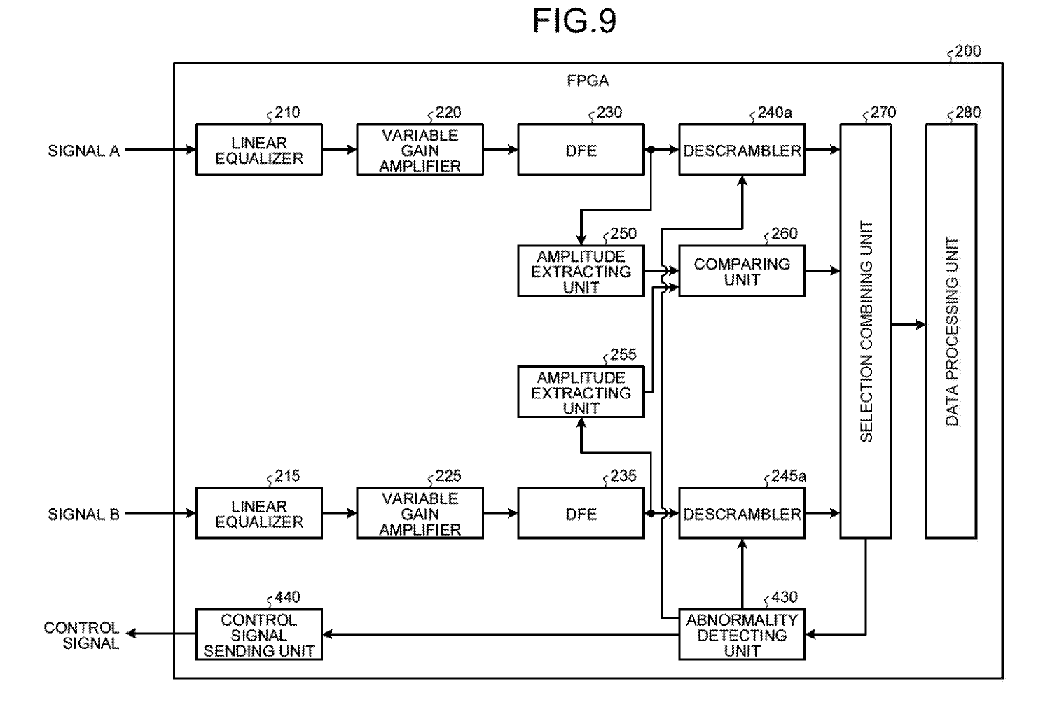

FIG. 9 is a block diagram illustrating the configuration of the receiving side FPGA 200 according to the third embodiment. In FIG. 9, components having the same configuration as those illustrated in FIG. 3 are assigned the same reference numerals and descriptions thereof will be omitted. The receiving side FPGA 200 illustrated in FIG. 9 has the configuration in which the descramblers 240 and 245 in the receiving side FPGA 200 illustrated in FIG. 3 are changed to descramblers 240a and 245a, respectively, and an abnormality detecting unit 430 and a control signal sending unit 440 are added.

The descramblers 240a and 245a perform the descrambling process on the signal A and the signal B by using the codes that are used by the scramblers 120a and 125a, respectively, in the sending side FPGA 100. Namely, the descrambler 240a obtains the data A from the signal A by performing inverse transformation of the scrambling process performed by the scrambler 120a. Furthermore, the descrambler 245a obtains the data B from the signal B by performing inverse transformation of the scrambling process performed by the scrambler 125a. Furthermore, because the scramblers 120a and 125a perform different scrambling processes on the same data, the data A and the data B match unless the effect, such as attenuation or the like, is present in the transmission line. The descramblers 240a and 245a output the data A and the data B, respectively, to the selection combining unit 270. At this time, the descramblers 240a and 245a output, a bit at a time, the data A and the data B to the selection combining unit 270.

Furthermore, the descramblers 240a and 245a change, in accordance with the instruction from the abnormality detecting unit 430, the codes used for the descrambling process.

The abnormality detecting unit 430 monitors the data selected by the selection combining unit 270 and determines whether the data to be selected is biased. Specifically, the abnormality detecting unit 430 monitors which one of the data A and the data B is selected by the selection combining unit 270 and compares the frequency of the selection of the respective pieces of the data. Namely, for example, in selection of the data performed a predetermined number of times by the selection combining unit 270, the abnormality detecting unit 430 calculates a difference between the number of times the data A has been selected and the number of times the data B has been selected. Then, the abnormality detecting unit 430 compares the calculated difference with a predetermined threshold and, if the difference is equal to or greater than a predetermined threshold, the abnormality detecting unit 310 detects that abnormality occurs in the transmission line.

Then, if the abnormality detecting unit 430 detects the abnormality of the transmission line, the abnormality detecting unit 430 instructs the descramblers 240a and 245a to perform the descrambling process by using a code that is different from the code that is currently being used. Specifically, the abnormality detecting unit 430 changes, in accordance with the same rule as that of the code management unit 420 in the sending side FPGA 100, the code that is used for the descrambling process. Accordingly, in also a case of changing the code, the abnormality detecting unit 430 instructs the descramblers 240a and 245a to use the same codes as those used by the scramblers 120a and 125a, respectively, to perform the scrambling process.

If abnormality of the transmission line is detected by the abnormality detecting unit 430, the control signal sending unit 440 sends the control signal indicating this status to the sending side FPGA 100.

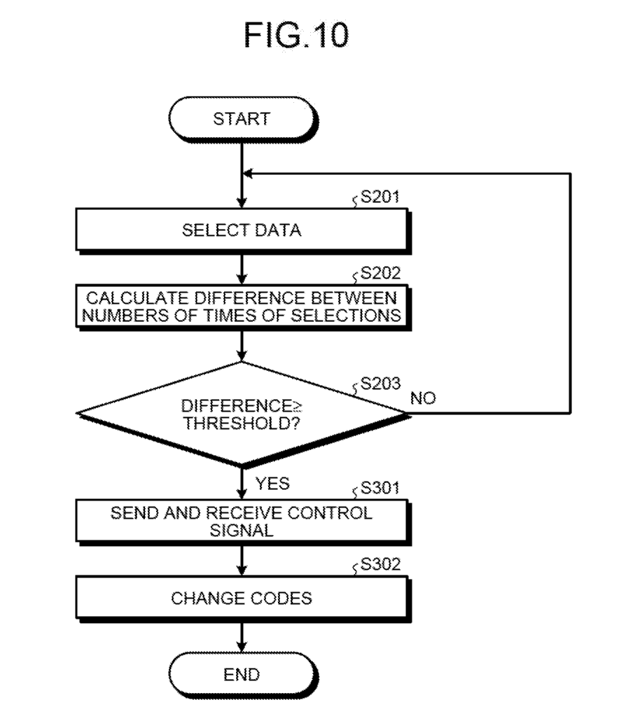

In the following, the abnormality detecting process performed by the receiving side FPGA 200 configured as described above will be described with reference to the flowchart illustrated in FIG. 10. In FIG. 10, processes having the same processes as those illustrated in FIG. 6 are assigned the same reference numerals.

In also the third embodiment, similarly to the first and the second embodiments, by comparing the amplitude A and the amplitude B of the signal A and the signal B, respectively, the data A or the data B is selected and output from the selection combining unit 270 (Step S201). The selection of the data performed by the selection combining unit 270 is monitored by the abnormality detecting unit 430 and, in the selection of the data performed the predetermined number of times, a difference between the number of times the data A has been selected and the number of times the data B has been selected is calculated (Step S202). Then, the calculated difference is compared with the predetermined threshold by the abnormality detecting unit 430 (Step S203).

If the result of this comparison indicates that the calculated difference is less than the predetermined threshold (No at Step S203), it is determined that the frequency of the selection of the data is not biased and determined that no abnormality is present in both the path A and the path B. Consequently, data A or the data B is continuously selected by comparing the amplitude A and the amplitude B of the signal A and the signal B, respectively.

In contrast, if the result of the comparison at Step S203 indicates that the calculated difference is equal to or greater than the predetermined threshold (Yes at Step S203), it is determined that the frequency of the selection of the data is biased and determined that abnormality is present in the transmission line. Consequently, the control signal indicating that abnormality is detected in the transmission line is sent from the control signal sending unit 440 to the sending side FPGA 100 and is received by the control signal receiving unit 410 in the sending side FPGA 100 (Step S301). Then, in the receiving side FPGA 200, the codes that are used by the respective descramblers 240a and 245a are changed by the abnormality detecting unit 430 and, in the sending side FPGA 100, the codes that are used by the respective scramblers 120a and 125a are changed by the code management unit 420 (Step S302).

Furthermore, the codes used by the respective scramblers 120a and 125a and the respective descramblers 240a and 245a regardless of whether the transmission line in which abnormality is detected by the abnormality detecting unit 430 is the path A or the path B. However, if the codes that are different between the scramblers and between the descramblers and that have low correlation with each other are used, it may also change only the codes used by the scrambler and the descrambler that are associated with the path in which the abnormality has been detected.

In this way, by changing the codes used for the scrambling process, the bit string of the signal transmitted by the transmission line is changed. Consequently, the spectrum of the signal is changed and the attenuation characteristic of the transmission line is also changed. Accordingly, the attenuation of the signal in the transmission line is reduced and the bias of the selection of the data may possibly be improved.

As described above, according to the embodiment, selecting data performed by comparing the amplitudes of the signals each have been transmitted by different transmission lines is monitored and, if the frequency of the selection is biased, it is detected that abnormality is present in the transmission line. Then, if abnormality is detected in the transmission line, the codes used for the scrambling process and the descrambling process are changed. Consequently, the spectrum of the signals transmitted by the transmission lines is changed, the attenuation characteristic of the signals is changed, and the bias of the selection of the data can be improved.

### [d] Fourth Embodiment

The characteristic of a fourth embodiment is that a selection rate is stored for each bit string of the signal transmitted by a plurality of transmission lines and abnormality of the transmission line is detected on the basis of the selection rate for each bit string.

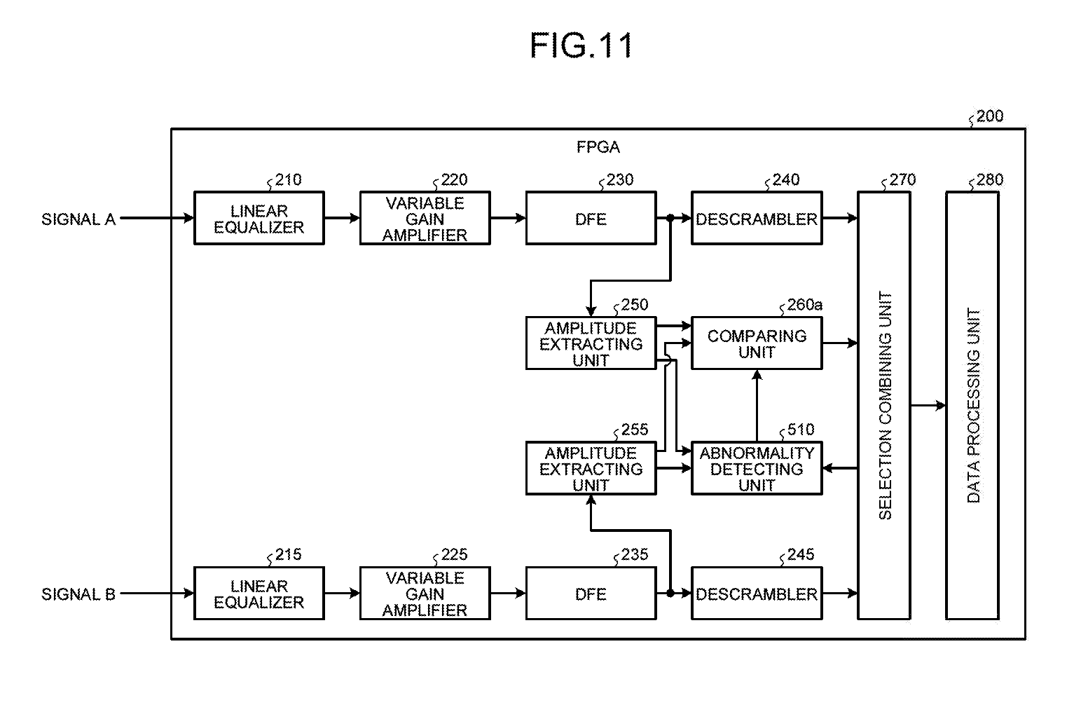

The configuration of the sending side FPGA according to the fourth embodiment is the same as that of the sending side FPGA 100 (FIG. 2) according to the first embodiment; therefore, descriptions thereof will be omitted. FIG. 11 is a block diagram illustrating the configuration of the receiving side FPGA 200 according to a fourth embodiment. In FIG. 11, components having the same configuration as those illustrated in FIGS. 3 and 5 are assigned the same reference numerals and descriptions thereof will be omitted. The receiving side FPGA 200 illustrated in FIG. 11 has the configuration in which the abnormality detecting unit 310 in the receiving side FPGA 200 illustrated in FIG. 5 is changed to an abnormality detecting unit 510.

The abnormality detecting unit 510 acquires the selection result of the data obtained by the selection combining unit 270, associates the acquired selection result with the continuously received bit string of the signal, and stores therein the selection rate for each path. Then, the abnormality detecting unit 510 refers to the selection rate associated with each of the bit strings at a predetermined period and detects that abnormality is present in the path containing the bit string in which the selection rate is lower than a predetermined threshold. Namely, the abnormality detecting unit 510 stores therein the selection rates by associating the selection rates with the bit strings of the signals transmitted by the respective paths and, if the bit string with a lower selection rate is present, the abnormality detecting unit 510 determines that abnormality is present in the path that transmits the subject bit string.

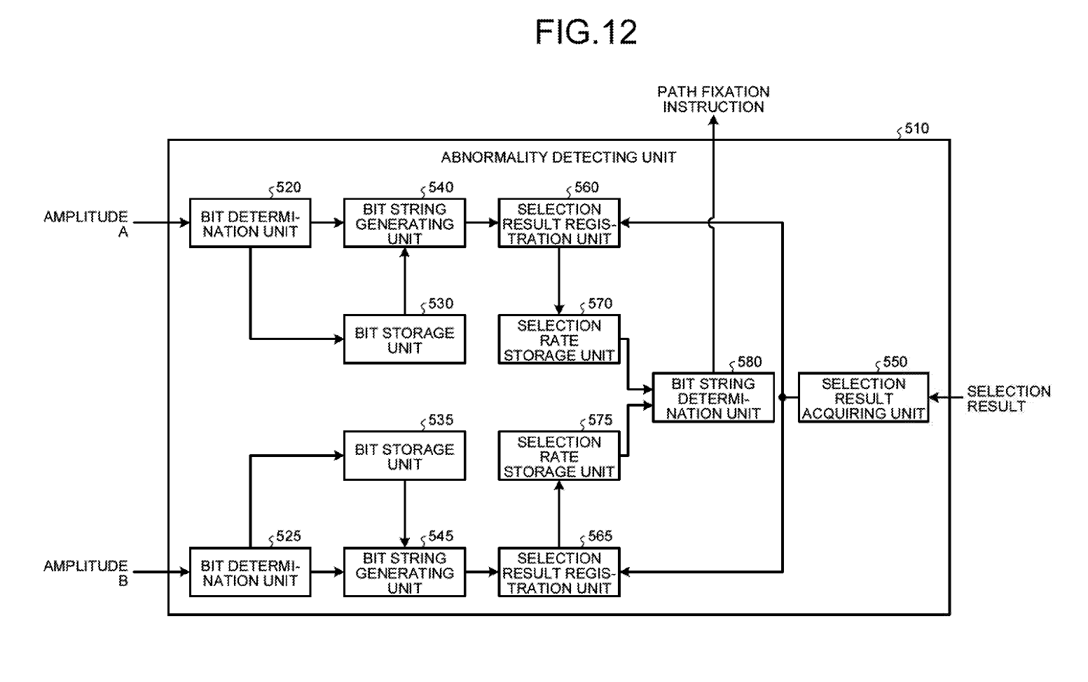

FIG. 12 is a block diagram illustrating the configuration of the abnormality detecting unit 510 according to the fourth embodiment. The abnormality detecting unit 510 illustrated in FIG. 12 includes bit determination units 520 and 525, bit storage units 530 and 535, bit string generating units 540 and 545, a selection result acquiring unit 550, selection result registration units 560 and 565, selection rate storage units 570 and 575, and a bit string determination unit 580.

The bit determination units 520 and 525 acquire the amplitudes extracted by the amplitude extracting units 250 and 255, respectively, and compare the amplitude with the predetermined reference amplitude, whereby the bit determination units 520 and 525 determine the bits indicated by the amplitudes. Namely, the bit determination unit 520 compares the amplitude A of the signal A with the predetermined reference amplitude and determines, if the amplitude A is equal to or greater than the predetermined reference amplitude, that the amplitude A indicates the bit of “1”, whereas determines, if the amplitude A is less than the predetermined reference amplitude, that the amplitude A indicates the bit of “0”. Similarly, the bit determination unit 525 compares the amplitude B of the signal B with the predetermined reference amplitude and determines, if the amplitude B is equal to or greater than the predetermined reference amplitude, the amplitude B indicates the bit of “1”, whereas determines, if the amplitude B is less than the predetermined reference amplitude, the amplitude B indicates the bit of “0”.

The bit storage units 530 and 535 temporarily store therein the bits determined by the bit determination units 520 and 525, respectively. Namely, the bit storage units 530 and 535 store therein the bit of “1” or “0” sequentially determined by the bit determination units 520 and 525, respectively, a predetermined number of bits at a time in the order of the bits that are newly determined and then delete the old bits the number of which exceeds the predetermined number.

If the determination of the bits is performed by the bit determination units 520 and 525, the bit string generating units 540 and 545 read the bits stored by the bit storage units 530 and 535, respectively, and generate respective bit strings in each of which the bits are arrayed in the order of the determination. Namely, the bit string generating units 540 and 545 generate the respective bit strings that have a predetermined length and that are continuously transmitted by the path A and the path B, respectively, until now.

The selection result acquiring unit 550 acquires the selection result every time the data is selected by the selection combining unit 270. Namely, the selection result acquiring unit 550 acquires the selection result indicating that the data A that has been transmitted via the path A or the data B that has been transmitted via the path B is selected.

If the selection result is acquired by the selection result acquiring unit 550, the selection result registration units 560 and 565 register the selection result by associating the selection result with the bit string generated by the bit string generating units 540 and 545, respectively. Namely, if the data A is selected, the selection result registration unit 560 notifies the selection rate storage unit 570 that the bit string generated by the bit string generating unit 540 has been selected. Furthermore, if the data B is selected, the selection result registration unit 560 notifies the selection rate storage unit 570 that the bit string generated by the bit string generating unit 540 has not been selected. Similarly, if the data B is selected, the selection result registration unit 565 notifies the selection rate storage unit 575 that the bit string generated by the bit string generating unit 545 has been selected. Furthermore, if the data A is selected, the selection result registration unit 565 notifies the selection rate storage unit 575 that the bit string generated by the bit string generating unit 545 has not been selected. The selection result associated with each of the respective bit strings indicate whether the data associated with the latest bit included in the bit string has been selected by the selection combining unit 270.

The selection rate storage units 570 and 575 calculate the selection rate for each bit string on the basis of the selection result for each bit string notified by the selection result registration units 560 and 565, respectively, and store the calculation result. Namely, the selection rate storage units 570 and 575 totalize the selection result for each bit string notified from the selection result registration units 560 and 565, respectively, and calculate the percentage of the selection related to each of the bit strings. The selection rate calculated in this way is the selection rate for each bit string when the respective bit strings with a predetermined length are transmitted by the path A and the path B. Because the spectra differ depending on the bit patterns of the bit strings, the selection rate for each bit string indicates whether attenuation in a specific frequency band in each of the paths is extremely large. In other words, if the selection rate of one of the bit strings is small, the attenuation in the frequency band associated with the subject bit string is large and it is conceivable that abnormality is present in the path that transmits the subject bit string.

The bit string determination unit 580 refers, at a predetermined period, to the selection rate for each bit string stored in the selection rate storage units 570 and 575 and determines whether the bit string in which the selection rate is less than a predetermined threshold is present. Then, if the bit string in which the selection rate is less than the predetermined threshold is present, the bit string determination unit 580 detects that abnormality has occurred in the path that transmits the subject bit string. Accordingly, if the bit string in which the selection rate is less than the predetermined threshold is stored in, for example, the selection rate storage unit 570, the bit string determination unit 580 detects that abnormality has occurred in the path A that transmits the subject bit string. Then, the bit string determination unit 580 instructs the comparing unit 260a to fixedly select the data that has passed through the path in which no abnormality is detected. Namely, if the bit string determination unit 580 detects that abnormality has occurred in, for example, the path A, the bit string determination unit 580 instructs the comparing unit 260a to fixedly select the data B that has passed through the path B.

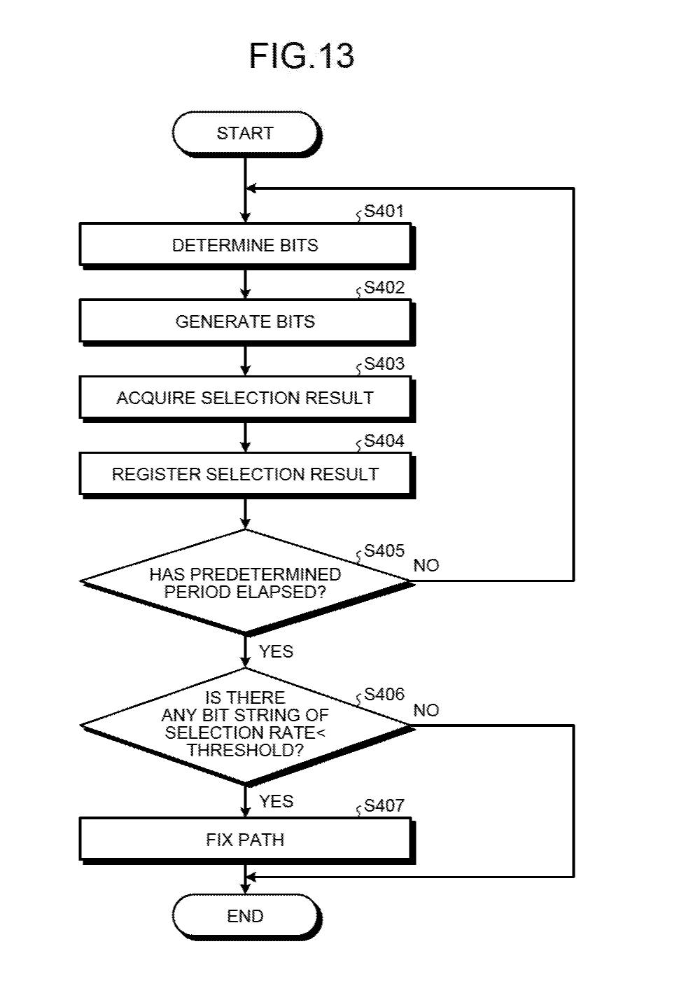

In the following, the abnormality detecting process performed by the receiving side FPGA 200 configured as described above will be described with reference to the flowchart illustrated in FIG. 13.

In also the fourth embodiment, similarly to the first embodiment, the amplitude A and the amplitude B of the signal A and the signal B are extracted by the amplitude extracting units 250 and 255, respectively. The amplitude A and the amplitude B extracted by the amplitude extracting units 250 and 255, respectively, are compared by the comparing unit 260a and are also input to the bit determination units 520 and 525, respectively, in the abnormality detecting unit 510. Then, the amplitude A and the amplitude B are compared by the predetermined threshold by the bit determination units 520 and 525, respectively, whereby the bits indicated by the amplitude A and the amplitude B are determined (Step S401). Specifically, the amplitude A is compared with the predetermined threshold by the bit determination unit 520 and, if the amplitude A is equal to or greater than the predetermined threshold, it is determined that the amplitude A indicates the bit “1” and, if the amplitude A is less than the predetermined threshold, it is determined that the amplitude A indicates the bit “0”. Similarly, the amplitude B is compared with the predetermined threshold by the bit determination unit 525 and, if the amplitude B is equal to or greater than the predetermined threshold, it is determined that the amplitude B indicates the bit “1” and, if the amplitude B is less than the predetermined threshold, it is determined that the amplitude B indicates the bit “0”.

The determined bits are stored by the bit storage units 530 and 535 and are output to the bit string generating units 540 and 545. Then, bit strings are generated, by the bit string generating units 540 and 545, from the bits that are output from the bit determination units 520 and 525 and from the bits that are stored by the bit storage units 530 and 535 (Step S402). Namely, bit strings with a predetermined length that are continuously transmitted by the respective path A and the path B are generated by the bit string generating units 540 and 545, respectively. Because short-term spectra differ depending on the bit patterns of the bit strings, the attenuation characteristics in the transmission lines in the respective bit strings differ.

In this way, the bit strings that are transmitted by the path A and the path B are generated from the amplitude A and the amplitude B, respectively, whereas, by comparing the amplitude A with the amplitude B, one of the data A and the data B is selected by the selection combining unit 270. Then, the selection result obtained by the selection combining unit 270 is acquired by the selection result acquiring unit 550 in the abnormality detecting unit 510 (Step S403). The acquired selection results are notified to the selection result registration units 560 and 565 and the bit strings and the selection results are registered in the selection rate storage units 570 and 575 by the selection result registration units 560 and 565, respectively (Step S404).

Specifically, the bit strings generated by the bit string generating units 540 and 545 are output to the selection result registration units 560 and 565, respectively, and, on the basis of the selection result notified to the selection result acquiring unit 550, the selection result indicating whether the respective bit strings are selected is notified to the respective selection rate storage units 570 and 575. Then, the selection rate of the respective bit strings is calculated and stored by the respective selection rate storage units 570 and 575. Namely, for each bit string, the ratio of the number of times selection has been performed to the sum total of the number of times selection has been performed and the number of times selection has not been performed is calculated as the selection rate. As described above, because short-term spectra differ depending on the bit patterns of the bit strings, if attenuation of a specific frequency band in the transmission line is large, it is conceivable that the selection rate of the bit string that has the spectrum associated with the subject frequency band becomes small.

In the bit string determination unit 580, a predetermined period in which a process of detecting abnormality in the transmission line is performed is counted. Namely, the bit string determination unit 580 determines whether a predetermined period has elapsed since the immediately previous abnormality detecting process (Step S405) and, if the predetermined period has not elapsed (No at Step S405), calculation of the selection rate for each bit string described above is repeated.

Then, if the predetermined period has elapsed since the immediately previous abnormality detecting process (Yes at Step S405), the selection rate storage units 570 and 575 are referred to by the bit string determination unit 580 and it is determined whether the bit string in which the selection rate is less than the predetermined threshold is present (Step S406). If the determination result indicates that the bit string in which the selection rate is less than the predetermined threshold is not present in the selection rate storage units 570 and 575 (No at Step S406), it is determined that abnormality does not occur in the transmission line and the process has been completed. In contrast, if the bit string in which the selection rate is less than the predetermined threshold is present in one of the selection rate storage units 570 and 575 (Yes at Step S406), it is determined that abnormality is present in the transmission line that has transmitted the subject bit string. Namely, if a bit string with an extremely small selection rate is present, because it is conceivable that the frequency band associated with the subject bit string greatly attenuated in the transmission line, abnormality of the transmission line can be detected from the selection rate of the bit string.

If the abnormality of the transmission line is detected, the comparing unit 260a is instructed, by the bit string determination unit 580, to fixedly select the data that has passed through the path in which no abnormality is present. In response to this instruction, the selection combining unit 270 is instructed, by the comparing unit 260a, to select the data that has passed through the instructed path regardless of whether the size of the amplitude. Consequently, the data that is output from the selection combining unit 270 to the data processing unit 280 is fixed to the data that has passed through the path in which no abnormality is present (Step S407).

As described above, according to the embodiment, a selection rate is calculated for each of the bit strings having a predetermined length of the signals transmitted by different transmission lines and, if the bit string in which the selection rate is less than the predetermined threshold is present, it is detected that abnormality is present in the transmission line that transmits the subject bit string. Then, the data associated with the signal transmitted by the transmission line in which no abnormality is present is fixedly selected. Consequently, it is possible to promptly detect abnormality in the transmission lines connected between the sending side FPGA and the receiving side FPGA, the data that has passed through the transmission line in which abnormality is present is not selected, and thus the error rate of the data can be reduced.

Furthermore, in the fourth embodiment described above, after the abnormality in the transmission line has been detected and the path of the selected data has been fixed, it may also possible to stop the calculation of the selection rate for each bit string. Namely, after path of the selected data has been fixed, because the selection result acquired by the selection result acquiring unit 550 is not the selection result obtained on the basis of the comparison of the amplitudes, the attenuation characteristic in the transmission line is not reflected in the selection result. Accordingly, if the selection rate is calculated by using the selection result obtained after having fixed the path, because the selection rate that has no relation with the state of the transmission line is calculated, calculation of the selection rate may also be stopped.

### [e] Fifth Embodiment

The characteristic of a fifth embodiment is that data is selected on the basis of the selection rate for each bit string.

In the fourth embodiment described above, the selection rate is calculated and stored for each bit string transmitted in the respective transmission lines. If the selection rate for each bit string is stored in this way, it is also possible to select data by using the selection rate. Thus, in a fifth embodiment, a description will be given of a process of selecting one of the data A and the data B by comparing the selection rate for each bit string. Furthermore, in the fifth embodiment, because it is preferable that the selection rate accurately reflect the attenuation characteristic of the transmission line, after the calculation of the selection rate for each bit string described above in the fourth embodiment is repeated in the predetermined period, selection of the data performed on the basis of the selection rate is started.

The configuration of a sending side FPGA according to the fifth embodiment is the same as that of the sending side FPGA 100 (FIG. 2) according to the first embodiment; descriptions thereof will be omitted. Furthermore, the configuration of a receiving side FPGA according to the fifth embodiment is the same as that of the receiving side FPGA 200 (FIG. 11) according to the fourth embodiment; therefore, descriptions thereof will be omitted. In the fifth embodiment, the internal configuration of the selection combining unit 270 in the receiving side FPGA 200 is different from that described in the fourth embodiment.

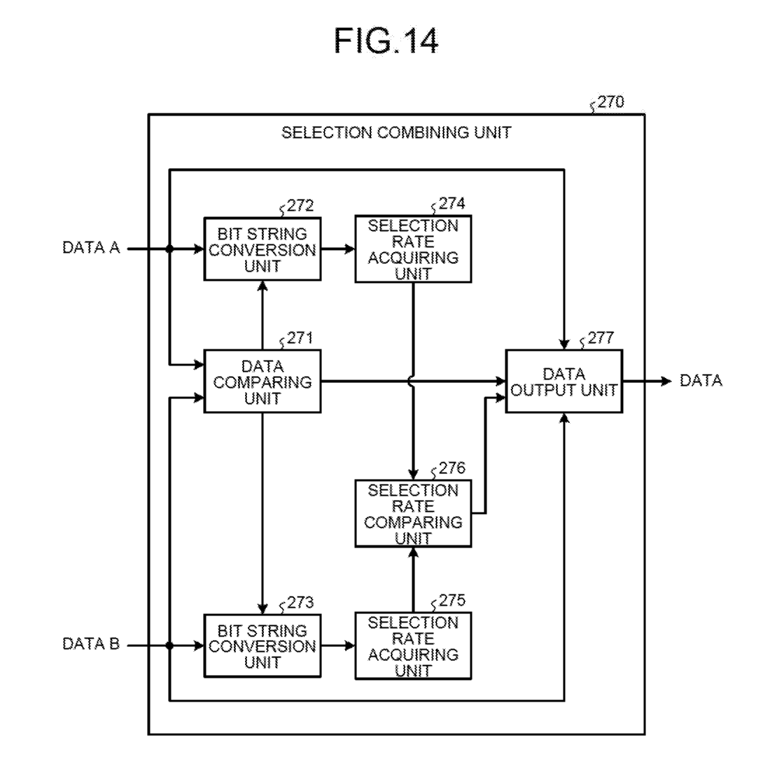

FIG. 14 is a block diagram illustrating the internal configuration of the selection combining unit 270 according to a fifth embodiment. The selection combining unit 270 illustrated in FIG. 14 includes a data comparing unit 271, bit string conversion units 272 and 273, selection rate acquiring units 274 and 275, a selection rate comparing unit 276, and a data output unit 277. Furthermore, in FIG. 14, a processing unit that selects data in accordance with the instruction from the comparing unit 260a is omitted.

The data comparing unit 271 compares the data A and the data B that are output from the descramblers 240 and 245, respectively, and determines whether the two pieces of the data match. Then, if the two pieces of the data match, the data comparing unit 271 notifies the data output unit 277 of this status. In contrast, if the two pieces of the data do not match, the data comparing unit 271 instructs the bit string conversion units 272 and 273 to convert the respective pieces of the data to the bit strings that have not been subjected to the descrambling process.

The bit string conversion units 272 and 273 accumulate the data A and the data B output from the descramblers 240 and 245, respectively, by an amount of a predetermined time period. Then, the bit string conversion units 272 and 273 convert, in accordance with the instruction from the data comparing unit 271, the accumulated data A and the data B, respectively, to the bit strings that have not been subjected to the descrambling process. Namely, the bit string conversion units 272 and 273 perform the scrambling process on the data A and the data B, respectively, corresponding to an amount of a predetermined time period by using the same codes as those used by the descramblers 240 and 245, respectively, and perform conversion by returning to the bit strings at the time of transmission in which these pieces of the data have been transmitted by the respective transmission lines. The length of the bit strings obtained by being converted by the bit string conversion units 272 and 273 is the same as that of the bit strings that are associated with the respective selection rates and stored by the selection rate storage units 570 and 575, respectively, in the abnormality detecting unit 510.

The selection rate acquiring units 274 and 275 acquire, from the selection rate storage units 570 and 575, respectively, the selection rates associated with the respective bit strings that are obtained by being converted by the bit string conversion units 272 and 273, respectively. Namely, the selection rate acquiring unit 274 acquires the selection rate that is associated with the bit string obtained by converting the data A from the selection rate storage unit 570. Furthermore, the selection rate acquiring unit 275 acquires the selection rate that is associated with the bit string obtained by converting the data B from the selection rate storage unit 575.

The selection rate comparing unit 276 compares the respective selection rates acquired by the selection rate acquiring units 274 and 275. Then, the selection rate comparing unit 276 instructs the data output unit 277 to output the data associated with the bit string in which the selection rate is greater. Namely, if, for example, the selection rate acquired by the selection rate acquiring unit 274 is greater than that acquired by the selection rate acquiring unit 275, the selection rate comparing unit 276 instructs the data output unit 277 to output the data A.

If the data output unit 277 is notified by the data comparing unit 271 that the data A and the data B match, the data output unit 277 outputs the data A or the data B both of which are the same with each other. Furthermore, if the data output unit 277 receives an instruction from the selection rate comparing unit 276 indicating the data to be output, the data output unit 277 outputs the data indicated between the data A and the data B.

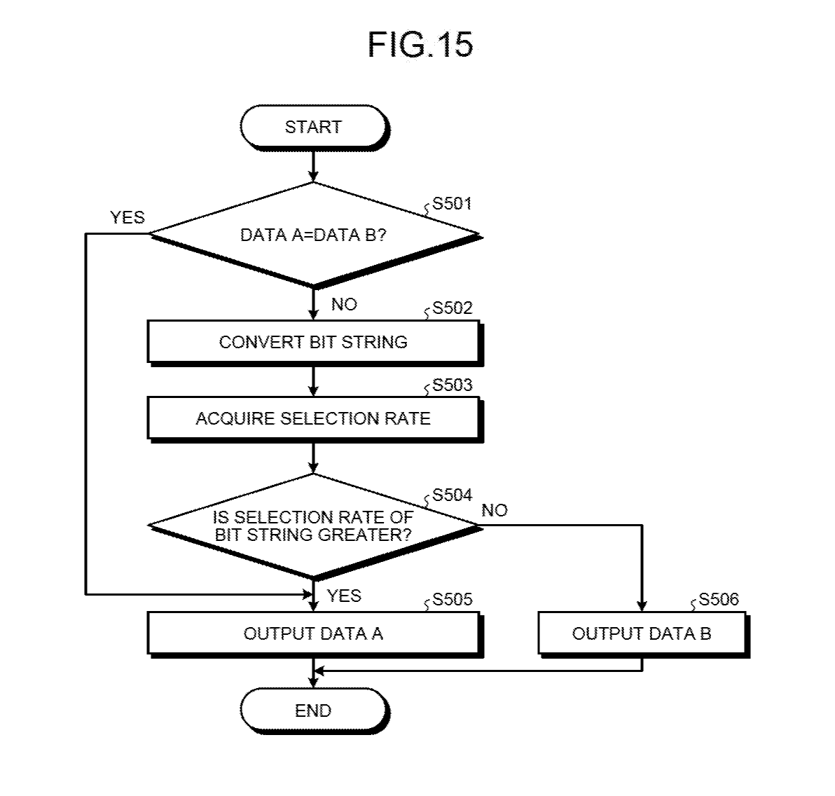

In the following, the data selecting process performed by the selection combining unit 270 configured as described above will be described with reference to the flowchart illustrated in FIG. 15.

If the data A and the data B that are obtained by being subjected to the descrambling process by the descramblers 240 and 245, respectively, are input to the selection combining unit 270, the data comparing unit 271 determines whether the data A and the data B match (Step S501). If the determination result indicates that the data A and the data B match (Yes at Step S501), this status is notified to the data output unit 277 and then the data A is output (Step S505). Furthermore, here, it is assumed that the data A is output; however, because the data A and the data B match, it is clear that, even if the data B is output, the same data is output.

In contrast, if the determination result at Step S501 indicates that the data A and the data B do not match (No at Step S501), the data A and the data B are converted, by the bit string conversion units 272 and 273, respectively, to the respective bit strings transmitted by the path A and the path B (Step S502). Specifically, the continuous predetermined number of pieces of data A is subjected to the scrambling process by the bit string conversion unit 272 by using the code used by the descrambler 240, whereby the bit string that has been transmitted by the path A is generated. Furthermore, the continuous predetermined number of pieces of data B is subjected to the scrambling process by the bit string conversion unit 273 by using the code used by the descrambler 245, whereby the bit string that has been transmitted by the path B is generated.

The generated bit strings are notified to the respective selection rate acquiring units 274 and 275 and the selection rates associated with the respective bit strings are acquired from the selection rate storage units 570 and 575 by the selection rate acquiring units 274 and 275, respectively (Step S503). The selection rates acquired at this time are the selection rates that indicate the ratio of data associated with the latest bits in the respective bit strings at the time of past transmission of the same bit strings as those transmitted by the respective path A and the path B. The acquired selection rates are compared by the selection rate comparing unit 276 and it is determined whether the selection rate of the bit string transmitted by the path A is greater than the selection rate of the bit string transmitted by the path B (Step S504).

If the determination result indicates that the selection rate of the bit string transmitted by the path A is greater (Yes at Step S504), the data output unit 277 is instructed to output the data A and then the data A is output from the data output unit 277 (Step S505). In contrast, if the selection rate of the bit string transmitted by the path B is greater (No at Step S504), the data output unit 277 is instructed to output the data B and then the data B is output from the data output unit 277 (Step S506).

As described above, according to the embodiment, if the pieces of the data obtained from the signals transmitted from different transmission lines do not match, the strings associated with continuous predetermined number of pieces of data are obtained and the selection rates at the time of past transmission of the respective bit strings are compared. Then, the data associated with the bit string in which the selection rate is greater is selected and output. Consequently, if the selection rate for each bit string is stored, optimum data can be selected without comparing the amplitudes.

Furthermore, in the fourth and the fifth embodiments described above, the selection rates of the bit strings that have not been subjected to the descrambling process are calculated and abnormality of the transmission line is detected or data is selected by using these selection rates. However, it is also possible to calculate the selection rates of respective data strings that have been subjected to the descrambling process and detect abnormality of a transmission line or select data by using the selection rates of the respective data strings. Namely, the selection rate is calculated, on the basis of the selection result with respect to the latest pieces of data included in the respective data strings, for each data string with a predetermined length formed by the pieces of data that are continuously output from the descramblers 240 and 245. Then, if a data string in which the calculated selection rate is less than a predetermined threshold is present, it may also be possible to detect that abnormality is present in the path that is associated with the subject data string. Furthermore, if the pieces of the data that are output from the descramblers 240 and 245 do not match, it may also possible to compare the selection rates of the subject data with the data string formed by a continuous predetermined number of pieces of data and then select the data associated with the data string in which the selection rate is greater.

### [f] Sixth Embodiment

The characteristic of a sixth embodiment is that the data that is obtained from the signal in which an amount of correction in the DFE is smaller is selected.

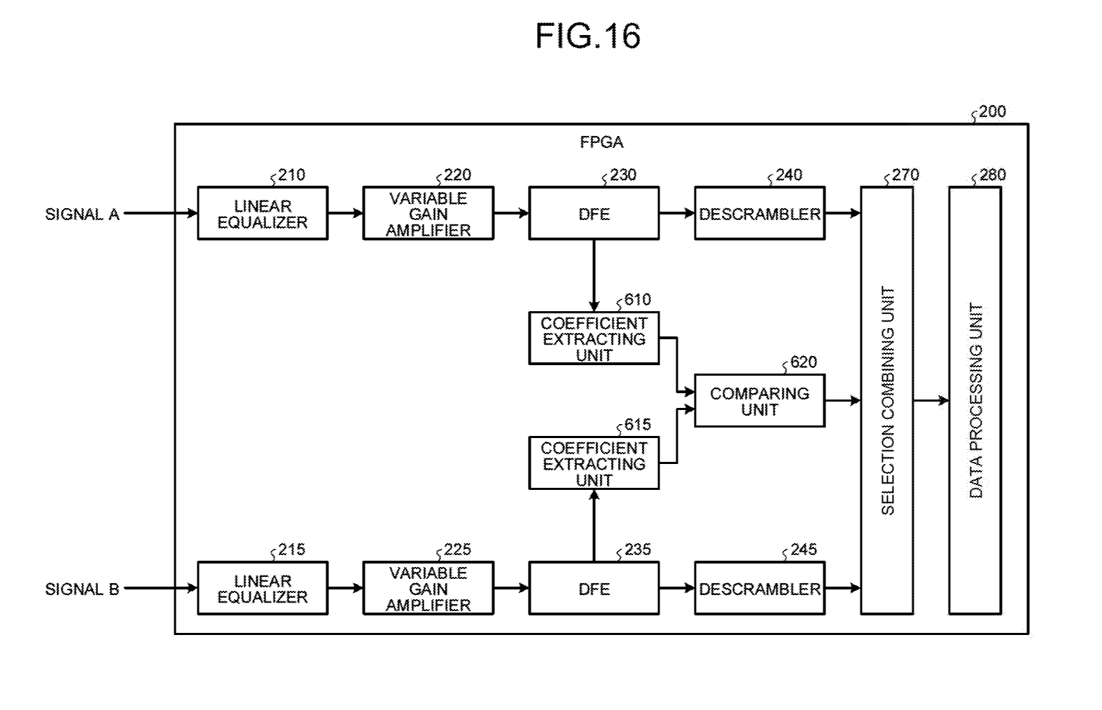

The configuration of the sending side FPGA according to a sixth embodiment is the same as that of the sending side FPGA 100 (FIG. 2) according to the first embodiment; therefore, descriptions thereof will be omitted. FIG. 16 is a block diagram illustrating the configuration of the receiving side FPGA 200 according to a sixth embodiment. In FIG. 16, components having the same configuration as those illustrated in FIG. 3 are assigned the same reference numerals and descriptions thereof will be omitted. The receiving side FPGA 200 illustrated in FIG. 16 has the configuration in which the amplitude extracting units 250 and 255 and the comparing unit 260 in the receiving side FPGA 200 illustrated in FIG. 3 is changed to coefficient extracting units 610 and 615, respectively, and a comparing unit 620, respectively.

The coefficient extracting units 610 and 615 extract tap coefficients that are used to correct the signals in the DFEs 230 and 235, respectively. Namely, because the DFEs 230 and 235 correct the signals while adjusting the tap coefficients, the coefficient extracting units 610 and 615 extract, from the DFEs 230 and 235, respectively, the tap coefficients indicating an amount of correction of the signal.

The comparing unit 620 compares the magnitude of the tap coefficients that are used to correct the signal A and the signal B and instructs the selection combining unit 270 to select the data associated with the signal in which the tap coefficient is small. Namely, if the tap coefficient related to the signal A is smaller than that of the signal B, the comparing unit 620 instructs the selection combining unit 270 to select the data A that is associated with the signal A. Furthermore, if the tap coefficient related to the signal B is smaller than that of the signal A, the comparing unit 620 instructs the selection combining unit 270 to select the data B that is associated with the signal B. As described above, because the tap coefficient indicates an amount of correction of the signal, if the tap coefficient is small, it is conceivable that correction of the signal is not much needed. Then, it is conceivable that an amount of correction of the signal is small is due to small attenuation in the transmission line with respect to the subject signal. Accordingly, by instructing the selection combining unit 270 to select the signal with a small tap coefficient, the comparing unit 620 instructs the selection combining unit 270 to select the signal in which attenuation in the transmission line is small.

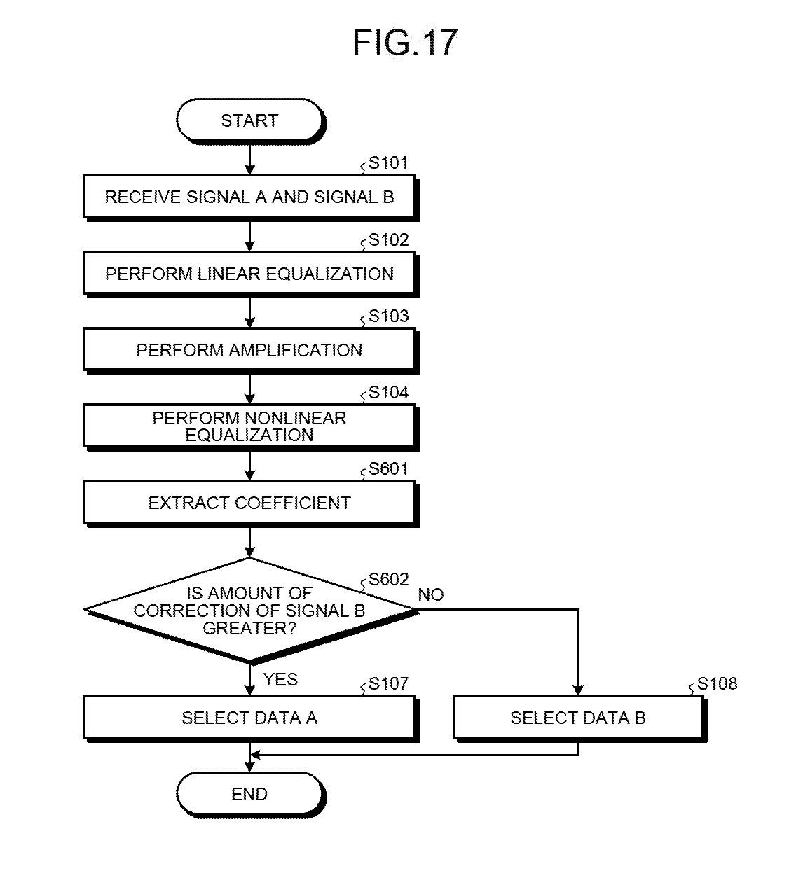

In the following, the data selecting process performed by the receiving side FPGA 200 configured as described above will be described with reference to the flowchart illustrated in FIG. 17. Furthermore, in FIG. 17, processes having the same configuration as those illustrated in FIG. 4 are assigned the same reference numerals and descriptions thereof in detail will be omitted.

The signal A and the signal B that are obtained by performing the scrambling process on the same data using different codes in the sending side FPGA 100 are transmitted by the different path A and the path B, respectively. The signal A and the signal B are received by the receiving side FPGA 200 (Step S101) and are subjected to linear equalization by the linear equalizers 210 and 215, respectively (Step S102). Then, the signal A and the signal B are amplified by the variable gain amplifiers 220 and 225, respectively, (Step S103) and are subjected to nonlinear equalization by the DFEs 230 and 235, respectively (Step S104). In the nonlinear equalization in the DFEs 230 and 235, the tap coefficients are adjusted due to a feed back of the signals, the adjusted tap coefficient is multiplied by the signal, and correction of the signal is performed.

The signal A and the signal B that has been processed, such as equalization or the like, are subjected to the descrambling process by the descramblers 240 and 245, respectively. For the descrambling process, the same codes as those used by the scramblers 120 and 125 in the sending side FPGA 100 are used. Due to the descrambling process, the data A is obtained from the signal A and the data B is obtained from the signal B. The data A and the data B are output from the selection combining unit 270.

The descrambling process is performed, whereas the tap coefficients adjusted in the DFEs 230 and 235 are extracted by the coefficient extracting units 610 and 615, respectively (Step S601). The tap coefficients that are extracted here indicate an amount of correction of each of the signal A and the signal B and an amount of correction of the signal is decreased as the tap coefficient is smaller and the attenuation in the transmission line is conceivably be small. Then, the magnitude of the extracted tap coefficients is compared by the comparing unit 620 (Step S602). Namely, the magnitude of the tap coefficient used to correct the signal A is compared with the magnitude of the tap coefficient used to correct the signal B by the comparing unit 620 and it is determined to select the data associated with the signal that has a small tap coefficient. Specifically, if the tap coefficient that is used to correct the signal B is greater and an amount of correction of the signal B is greater (Yes at Step S602), it is determined to select the data A associated with the signal A (Step S107) and this status is notified to the selection combining unit 270. In contrast, if the tap coefficient that is used to correct the signal B is smaller and an amount of correction pf the signal B is smaller (No at Step S602), it is determined to select the data B that is associated with the signal B (Step S108) and this status is notified to the selection combining unit 270.

If the selection result of the data is notified to the selection combining unit 270, the data that is in accordance with the selection result is output to the data processing unit 280 by the selection combining unit 270. Namely, if the data A is selected, the data A output from the descrambler 240 is output to the data processing unit 280, whereas, if the data B is selected, the data B output from the descrambler 245 is output to the data processing unit 280. A process that is in accordance with predetermined programs installed in the receiving side FPGA 200 is performed on these data by the data processing unit 280.

In this way, in the receiving side FPGA 200, the tap coefficients that indicate the amount of correction of the signal A and the signal B are compared and the data that is obtained by performing the descrambling process on the signal with a small tap coefficient is selected. Consequently, the data that is obtained from the signal that is attenuated due to, for example, the effect of reflection and in which an amount of correction is large due to nonlinear equalization is not selected and thus it is possible to reduce the error rate of the selected data.

As described above, according to the embodiment, the receiving side FPGA performs, by using the same codes as that used for the scrambling process, descrambling process on the signals transmitted by different transmission lines and selects the data, between the pieces of the obtained data, that is associated with the signal in which an amount of correction of the nonlinear equalization is small. Consequently, it is possible to select the data obtained from the signal in which the effect, such as reflection with respect to the high-frequency component, is small and it is possible to reduce the error rate of the data. In other words, attenuation of the signal with a high-frequency band can be sufficiently compensated.

Furthermore, in each of the embodiments described above, a case in which signals are transmitted between the sending side FPGA 100 and the receiving side FPGA 200 has been described; however, in addition to the transmission of the signals between the FPGAs, each of the embodiments described above may also be used. Namely, by providing scramblers, descramblers, or the like that are the same as those used in each of the embodiments described above in electronic components that send and receive signals with each other via transmission lines, it is possible to sufficiently compensate attenuation of signals in a high-frequency band.

Furthermore, these electronic components do not always need to be mounted on the same printed circuit board. Namely, the transmission lines that connect the electronic components may also be formed by only the transmission lines in the inner layer of the printed circuit board or may also include transmission lines between different printed circuit boards on each of which an electronic component is mounted. Furthermore, these transmission lines may also include transmission lines outside a housing, such as, a base station device, an information processing apparatus, or the like.

According to an aspect of an embodiment of the base station device, the transmission system, and the transmission method disclosed in the present invention, an advantage is provided in that it is possible to sufficiently compensate attenuation of signals in a high-frequency band.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station device comprising:
a first electronic component; and
a second electronic component configured to connect to the first electronic component, wherein
the first electronic component includes
a generator configured to generate data,
a plurality of scramblers configured to perform, by using different codes, a scrambling process on the data generated by the generator, and
a sending driver configured to send, by using different transmission lines, a plurality of signals obtained by being subjected to the scrambling process by the plurality of the respective scramblers to the second electronic component, and
the second electronic component includes
a receiver configured to receive the plurality of the signals transmitted by the sending driver,
a plurality of descramblers configured to perform, by using the codes used by the respective scramblers, a descrambling process on the plurality of the signals received by the receiver, and
a selector configured to select one of a plurality of pieces of data obtained by being subjected to the descrambling process by the plurality of the respective descramblers.

2. The base station device according to claim 1, wherein
the second electronic component further includes
an amplitude extractor configured to extract amplitudes of the plurality of the signals received by the receiver, and
a comparator configured to compare the amplitudes of the plurality of the signals extracted by the amplitude extractor, wherein
the selector selects, based on a result of comparison performed by the comparator, data that is associated with a signal having the maximum amplitude.

3. The base station device according to claim 1, wherein,
the sending driver sends the plurality of signals by using a plurality of transmission lines, and
the receiver receives the plurality of the signals transmitted by the sending driver by the respective transmission lines.

4. The base station device according to claim 3, the second electronic component further includes a detector configured to monitor selection frequency, at the selector, of pieces of the data associated with the respective transmission lines and to detect abnormality of the transmission line based on the selection frequency.

5. The base station device according to claim 4, wherein the detector calculates a difference between numbers of times the pieces of the data associated with the respective transmission lines are selected and detects, when the calculated difference is equal to or greater than a predetermined threshold, the abnormality of the transmission line.

6. The base station device according to claim 4, wherein, when the detector detects the abnormality of the transmission line, the detector instructs the selector to select the data that is associated with a transmission line in which no abnormality is detected.

7. The base station device according to claim 4, wherein, when the detector detects the abnormality of the transmission line, the detector notifies a higher-level device that the abnormality of the transmission line is detected.

8. The base station device according to claim 4, wherein
the second electronic component further includes
a control signal sending driver configured to send, when the abnormality of the transmission line is detected by the detector, a control signal indicating that the abnormality of the transmission line is detected, and
the first electronic component further includes
a control signal receiver configured to receive the control signal sent by the control signal sending driver, wherein
when the control signal is received by the control signal receiver, the codes that are used by the plurality of the scramblers are changed based on the control signal.

9. The base station device according to claim 4, wherein
the second component further includes
a bit string generator configured to generate bit strings that are formed by bits included in the plurality of the respective signals received by the receiver and that include a predetermined number of bits that are continuously transmitted by the plurality of the respective transmission lines, and
a selection rate storage configured to store therein, in an associated manner with the bit strings generated by the bit string generator, selection rates, at the selector, of the pieces of data that are associated with the latest bits included in the respective bit strings, and
the detector detects the abnormality of the transmission line when a bit string in which the selection rate is less than a predetermined threshold is stored in the selection rate storage.

10. The base station device according to claim 9, wherein
the selector includes
a bit string converter configured to convert a predetermined number of pieces of data obtained by continuously being subjected to the descrambling process by the plurality of the respective descramblers to bit strings that are not subjected to the descrambling process, and
a selection rate acquiring unit that acquires, from the selection rate storage, the selection rates that are associated with the respective bit strings obtained by being converted by the bit string convertor, and
the selector selects the data that is associated with the transmission line that has transmitted the bit string that has the greatest selection rate acquired by the selection rate acquiring unit.

11. The base station device according to claim 4, wherein
the detector includes
a data string generator configured to generate data strings that includes a predetermined number of pieces of the data obtained by continuously being subjected to the descrambling process by the plurality of the respective descramblers, and
a selection rate storage configured to store therein, in an associated manner with the data strings generated by the data string generator, selection rates, at the selector, of the latest pieces of data included in the respective data strings, and
the detector detects the abnormality of the transmission line when a bit string in which the selection rate is less than a predetermined threshold is stored in the selection rate storage.

12. The base station device according to claim 11, wherein
the selector includes a selection rate acquiring unit that acquires, from the selection rate storage, after the selection rates in a predetermined time period at the selector are stored in the selection rate storage, the selection rates that are associated with the respective bit strings generated by the data string generator, and
the selector selects the latest pieces of data included in the respective data strings in each of which the selection rate acquired by the selection rate acquiring unit is the greatest.

13. The base station device according to claim 1, wherein
the second electronic component further includes
a plurality of correctors configured to correct the plurality of the respective signals received by the receiver, to feed back the respective corrected signals, and to adjust amounts of correction, and
the selector includes
an extractor configured to extract the amounts of correction of the respective signals obtained by the plurality of the respective correctors, and
a comparator configured to compare the amounts of correction of the plurality of the respective signals extracted by the extractor, and
the selector selects, based on a result of comparison performed by the comparator, the data associated with the signal in which the amount of correction is the smallest.

14. A transmission system comprising:
a first electronic component; and
a second electronic component connected to the first electronic component, wherein
the first electronic component includes
a generator configured to generate data,
a plurality of scramblers configured to perform, by using different codes, a scrambling process on the data generated by the generator, and
a sending driver configured to send a plurality of signals obtained by being subjected to the scrambling process by the plurality of the respective scramblers, and
the second electronic component includes
a receiver configured to receive the plurality of the signals,
a plurality of descramblers configured to perform, by using the codes used by the respective scramblers, a descrambling process on the plurality of the signals received by the receiver, and
a selector configured to select one of a plurality of pieces of data obtained by being subjected to the descrambling process by the plurality of the respective descramblers.

15. A transmission method performed between a first electronic component and a second electronic component that are connected, the transmission method comprising:
generating data by the first electronic component;
performing, by using different codes, a scrambling process on the generated data by the first electronic component;
sending a plurality of signals obtained by being subjected to the scrambling process by the first electronic component;
receiving the plurality of the signals by the second electronic component;
performing, by using the respective codes used by the scrambling process, a descrambling process on the plurality of the respective received signals by the second electronic component; and
selecting one of a plurality of pieces of data obtained by being subjected to the descrambling process by the second electronic component.
